(19) United States
(12) Patent Application Publication
(10) Pub. No.: US 2021/0268877 A1
(43) Pub. Date: Sep. 2, 2021

(54) MULTI-TEMPERATURE TRANSPORT REFRIGERATION SYSTEM AND METHOD

(71) Applicant: CARRIER CORPORATION, Palm Beach Gardens, FL (US)

(72) Inventor: Mark J. Perkovich, Fayetteville, NY (US)

(21) Appl. No.: 17/255,244

(22) PCT Filed: Jun. 6, 2019
(86) PCT No.: PCT/US2019/035702

§ 371 Date: Dec. 22, 2020

Related U.S. Application Data
(60) Provisional application No. 62/688,683, filed on Jun. 22, 2018.

(51) Int. Cl. B60H 1/32

(52) U.S. Cl. CPC B60H 1/32281; B60H 1/3232

(57) ABSTRACT

A transport refrigeration system (100) including a container (10) having an outer wall defining at least one compartment. Also included is a first refrigerant system section (202) disposed at an exterior location of the outer wall of the container, the first refrigerant system section having a first refrigerant routed therethrough for cooling of the first refrigerant. Further included is a second refrigerant system (204) section disposed at least partially within an interior location of the outer wall of the container, the second refrigerant system section having a second refrigerant that is different from the first refrigerant routed therethrough for cooling of the second refrigerant. Yet further included is a heat exchanger (240) in fluid communication with the first refrigerant system section to receive the first refrigerant, the heat exchanger in fluid communication with the second refrigerant system section to receive the second refrigerant, the first refrigerant cooling the second refrigerant within the heat exchanger.

### BACKGROUND

This disclosure relates generally to transport refrigeration systems and, more particularly, to a multi-temperature refrigeration system utilized in transport refrigeration systems.

A transport refrigeration system used to control enclosed areas, such as the insulated box used on trucks, trailers, containers, or similar intermodal units, functions by absorbing heat from the enclosed area and releasing heat outside of the box into the environment. Refrigeration for multi-temperature refrigerated trailers is fairly complicated and costly. Environmental concerns associated with certain refrigerants may lead to mandates for the use of flammable or mildly-flammable refrigerants, but there is a concern for systems that use such refrigerants because, as currently designed, multi-temperature refrigeration systems have the operative refrigerants running inside the trailer box. Leaking of such refrigerants in a trailer box is undesirable.

### BRIEF SUMMARY

Disclosed is a transport refrigeration system including a container having an outer wall defining at least one compartment therein. Also included is a first refrigerant system section disposed at an exterior location of the outer wall of the container, the first refrigerant system section having a first refrigerant routed therethrough for cooling of the first refrigerant. Further included is a second refrigerant system section disposed at least partially within an interior location of the outer wall of the container, the second refrigerant system section having a second refrigerant that is different from the first refrigerant routed therethrough for cooling of the second refrigerant. Yet further included is a heat exchanger in fluid communication with the first refrigerant system section to receive the first refrigerant, the heat exchanger in fluid communication with the second refrigerant system section to receive the second refrigerant, the first refrigerant cooling the second refrigerant within the heat exchanger.

In addition to one or more of the features described above, or as an alternative, further embodiments may include that the second refrigerant is carbon dioxide.

In addition to one or more of the features described above, or as an alternative, further embodiments may include that the first refrigerant is one of HFC, HFO, and A2L.

In addition to one or more of the features described above, or as an alternative, further embodiments may include that the first refrigerant system section comprises a compressor, a condenser downstream of the compressor, and a first receiver, the heat exchanger in fluid communication with the receiver to selectively route the first refrigerant from the first receiver to the heat exchanger.

In addition to one or more of the features described above, or as an alternative, further embodiments may include that the second refrigerant system section includes a second receiver in fluid communication with the heat exchanger to receive the second refrigerant in a saturated or subcooled liquid state from the heat exchanger. The second refrigerant system section also includes at least one evaporator downstream of the second receiver to receive the second refrigerant in a liquid state from the second receiver, the evaporator(s) for partial evaporation of the second refrigerant, a vapor portion of the second refrigerant utilized for cooling an interior of the compartment, a two-phase portion of the second refrigerant routed from the evaporator(s) to the heat exchanger.

In addition to one or more of the features described above, or as an alternative, further embodiments may include that the second refrigerant is pumped from the second receiver to at least one evaporator with a pump disposed between the second receiver and at least one evaporator, the flow to each evaporator regulated by a respective valve.

In addition to one or more of the features described above, or as an alternative, further embodiments may include that the valve(s) is a solenoid valve, the flow of the second refrigerant regulated based on demand for each of the at least one evaporator.

In addition to one or more of the features described above, or as an alternative, further embodiments may include that the container defines a plurality of compartments, each of the plurality of compartments allowing different controlled environmental conditions therein.

In addition to one or more of the features described above, or as an alternative, further embodiments may include that the second refrigerant system section includes a second receiver in fluid communication with the heat exchanger to receive the second refrigerant in a cooled liquid state from the heat exchanger. The second refrigerant system section also includes at least one evaporator downstream of the second receiver to receive the second refrigerant in a liquid state from the second receiver, the evaporator(s) for partial evaporation of the second refrigerant, a vapor portion of the second refrigerant utilized for cooling an interior of the compartment, a two-phase portion of the second refrigerant routed from the evaporator(s) back to the second receiver. The second refrigerant system section further includes a cooling pump for pumping the second refrigerant in a warmed liquid state from the second receiver to the heat exchanger for cooling therein.

In addition to one or more of the features described above, or as an alternative, further embodiments may include that the cooling pump is initiated when the pressure within the second receiver exceeds a predefined pressure.

In addition to one or more of the features described above, or as an alternative, further embodiments may include that the second refrigerant is pumped from the second receiver to the at least one evaporator with a pump disposed between the second receiver and the at least one evaporator, the flow to each evaporator regulated by a respective valve.

In addition to one or more of the features described above, or as an alternative, further embodiments may include that the valve(s) is a solenoid valve, the flow of the second refrigerant regulated based on demand for each of the at least one evaporator.

Also disclosed is a method of regulating an environment of a transport container. The method includes cooling a first refrigerant within a first refrigerant system section that is disposed at an exterior location of an outer wall of the transport container. The method also includes cooling a second refrigerant within a second refrigerant system section that is at least partially disposed within an interior location of the outer wall of the transport container, the second refrigerant cooled by the first refrigerant in a heat exchanger, the first and second refrigerants different from each other.

In addition to one or more of the features described above, or as an alternative, further embodiments may include that cooling the second refrigerant within the second refrigerant system section includes routing the second refrigerant from the heat exchanger to a receiver for storage therein. Also included is pumping the second refrigerant from the receiver to at least one evaporator for partial evaporation of the second refrigerant. Further included is routing the partially evaporated second refrigerant from the evaporator to the heat exchanger.

In addition to one or more of the features described above, or as an alternative, further embodiments may include that cooling the second refrigerant within the second refrigerant system section includes routing the second refrigerant from the heat exchanger to a receiver for storage therein. Also included is pumping the second refrigerant from the receiver to at least one evaporator for partial evaporation of the second refrigerant. Further included is routing the partially evaporated second refrigerant from the evaporator to the receiver. Yet further included is monitoring a pressure within the receiver. Also included is pumping the second refrigerant from the receiver to the heat exchanger when the pressure within the receiver exceeds a predetermined pressure for cooling the second refrigerant.

### BRIEF DESCRIPTION OF THE DRAWINGS

The present disclosure is illustrated by way of example and not limited in the accompanying figures in which like reference numerals indicate similar elements.

FIG. 1 is a diagram of a transport refrigeration system;

FIG. 2 schematically illustrates a refrigeration system for a transport refrigeration unit of the transport refrigeration system; and

FIG. 3 is a schematic illustration of the refrigeration system according to another aspect of the disclosure.

### DETAILED DESCRIPTION

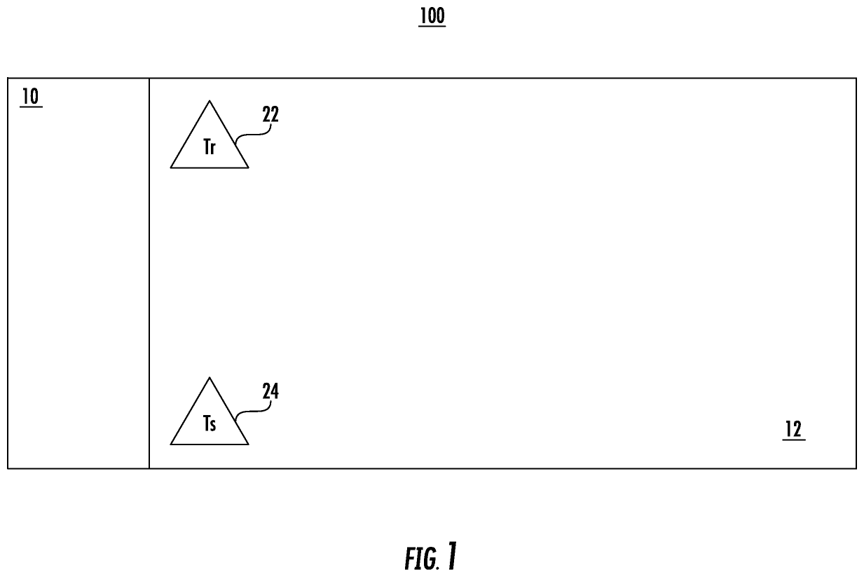

FIG. 1 is a diagram that shows an embodiment of a transport refrigeration system. As shown in FIG. 1, a transport refrigeration system 100 can include a transport refrigeration unit 10 coupled to an enclosed space within a container 12. As shown in FIG. 1, the transport refrigeration unit 10 is configured to maintain a prescribed thermal environment within the container 12 (e.g., cargo in an enclosed volume).

In FIG. 1, the transport refrigeration unit 10 is connected at one end of the container 12. Alternatively, the transport refrigeration unit 10 can be coupled to a prescribed position on a side or more than one side of the container 12. In one embodiment, a plurality of transport refrigeration units can be coupled to a single container 12. Alternatively, a single transport refrigeration unit 10 can be coupled to a plurality of containers 12. The transport refrigeration unit 10 can operate to induct air at a first temperature and to exhaust air at a second temperature. In one embodiment, the exhaust air from the transport refrigeration unit 10 will be warmer than the inducted air such that the transport refrigeration unit 10 is employed to warm the air in the container 12. In one embodiment, the exhaust air from the transport refrigeration unit 10 will be cooler than the inducted air such that the transport refrigeration unit 10 is employed to cool the air in the container 12. The transport refrigeration unit 10 can induct air from the container 12 having a return temperature Tr (e.g., first temperature) and exhaust air to the container 12 having a supply temperature Ts (e.g., second temperature).

In one embodiment, the transport refrigeration unit 10 can include one or more sensors (wired or wireless) to continuously or repeatedly monitor conditions or operations for the transport refrigeration unit 10. As shown in FIG. 1, exemplary sensors can include a first temperature sensor 24 of the transport refrigeration unit 10 that can provide the supply temperature Ts and a second temperature sensor 22 of the transport refrigeration unit 10 that can provide the return temperature Tr to the transport refrigeration unit 10, respectively.

A transport refrigeration system 100 can provide air with controlled temperature, humidity or/and species concentration into an enclosed chamber where cargo is stored such as in container 12. As known to one skilled in the art, the transport refrigeration system 100—with a controller—is capable of controlling a plurality of the environmental parameters or all the environmental parameters within corresponding ranges with a great deal of variety of cargos and under all types of ambient conditions.

The transport refrigeration unit 10 can be operatively coupled to a container (not shown), which can be used with a trailer, an intermodal container, a train railcar, a ship or the like, used for the transportation or storage of goods requiring a temperature controlled environment, such as, for example foodstuffs and medicines (e.g., perishable or frozen). The container can include an enclosed volume for the transport/storage of such goods. The enclosed volume may be an enclosed space having an interior atmosphere isolated from the outside (e.g., ambient atmosphere or conditions) of the container.

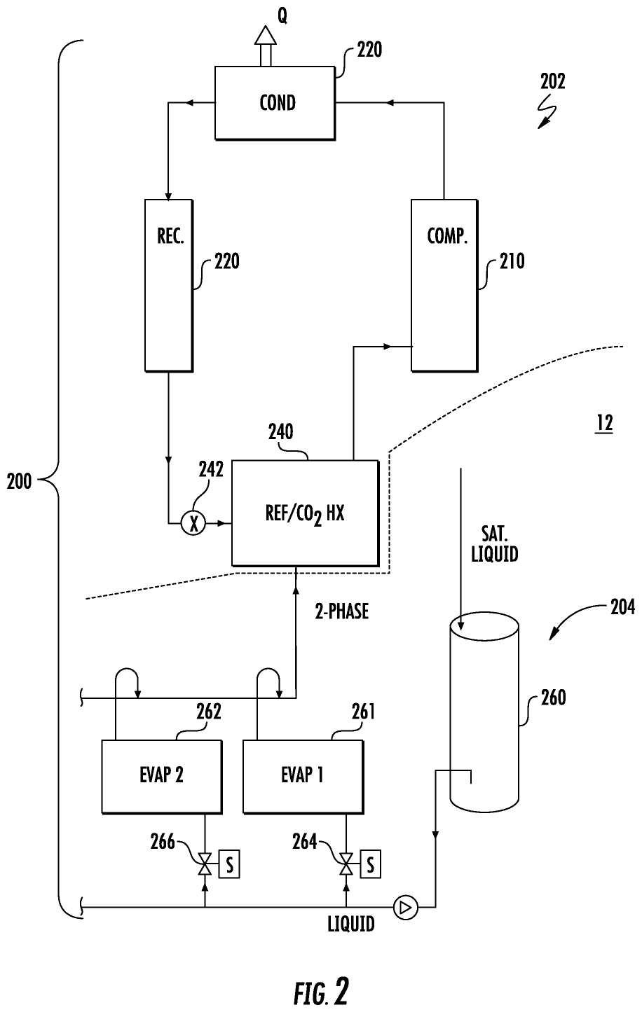

FIG. 2 is a schematic diagram illustrating a refrigeration system 200 of the transport refrigeration unit 10. As will be appreciated from the description herein, the refrigeration system 200 includes two main sections. Specifically, a first refrigeration system section 202 is located completely at an exterior location of the container 12. The exterior location refers to any location outwardly of a container wall that separates the enclosed cargo space from the ambient conditions, thereby fully disposing the first refrigeration system section 202 outside of the enclosed space of the container 12. The refrigeration system 200 also includes a second refrigeration system section 204 located at an interior location of the container 12. In some embodiments, the second refrigeration system section 204 is located partially within the container 12. In other embodiments, the second refrigeration system 204 is located completely within the container. The interior location refers to any location inwardly of the container wall that separates the enclosed cargo space from the ambient conditions.

The first refrigeration system section 202 has a first refrigerant routed therethrough. The first refrigerant may be referred to herein as a primary refrigerant that is utilized to cool a second refrigerant that is routed through the second refrigeration system 204, as described herein. In some embodiments, the first refrigerant is HFC, HFO, A2L, or some other commonly utilized refrigerant for purposes of transport refrigeration. The preceding list is not intended to be limiting and it is to be understood that other refrigerants may be employed.

The first refrigeration system section 202 incudes a compressor 210 that compresses the first refrigerant to provide a high temperature, high pressure refrigerant vapor for exit from the compressor 210. The first refrigerant then moves to an air-cooled condenser 220, which can include a plurality of condenser coil fins and tubes which receive air, typically blown by a condenser fan. By removing latent heat through the condenser 220, the first refrigerant condenses to a high pressure/high temperature liquid and flows to a receiver 230 that can provide storage for excess liquid refrigerant during low temperature operations. From the receiver 230, the first refrigerant proceeds into a heat exchanger 240, where the first refrigerant is fully evaporated to a vapor state. Any segment of first refrigerant routing may be selectively controlled with a valve, such as the valve 242 shown between the receiver 230 and the heat exchanger 240.

The second refrigeration system section 204 has a second refrigerant routed therethrough. The second refrigerant may be referred to herein as a secondary refrigerant that is cooled by the first (e.g., primary) refrigerant and then utilized to cool the enclosed cargo space of the container 12. In some embodiments, the second refrigerant is carbon dioxide (CO2). Carbon dioxide has been found to be advantageous for refrigeration purposes within a transport refrigeration application, however, it is contemplated that a different refrigerant may be employed, as long as it is suitable for use within the container and is distinct from the first refrigerant.

The second refrigeration system section 204 is a pumped liquid-overfeed system. In other words, the second refrigerant (e.g., CO2) is pumped with a pump 250 from a low-pressure receiver 260 to one or more evaporators. In the illustrated embodiment, a first evaporator 261 and a second evaporator 262 are utilized, but it is to be appreciated that more or fewer evaporators may be employed in the loop. Each evaporator 261, 262 selectively receives the second refrigerant by regulation of the fluid via a respective valve 264, 266. The valves 264, 266 may be any type of flow regulating device, such as solenoid valves, as illustrated. The evaporators 261, 262 each partially evaporate the liquid state of the second refrigerant, resulting in a two-phase mixture. The mixture is routed to the heat exchanger 240. As described above, the first refrigerant is present in the heat exchanger 240 and cools the second refrigerant therein, thereby condensing the second refrigerant back to a saturated/subcooled liquid.

The loop of the second refrigeration system section 204 is completed upon return of the second refrigerant to the receiver 260. The receiver 260 is a low-pressure receiver. The term “low-pressure” refers to a low pressure relative to the second refrigerant pressure.

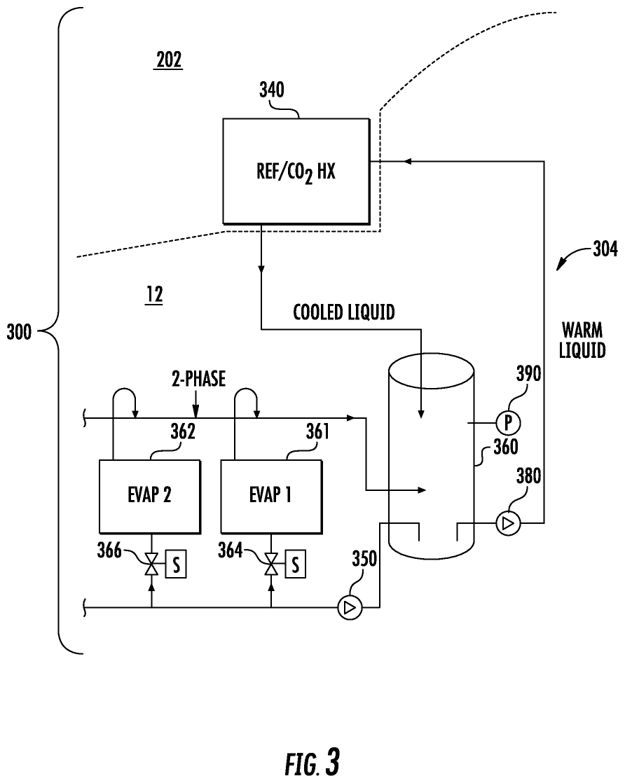

Referring now to FIG. 3, another embodiment of the refrigeration system illustrated and is referenced generally with numeral 300. The illustrated embodiment includes a first refrigerant system section 202 that is identical to that described above in connection with FIG. 2. The first section 202 is not described or illustrated in duplicate. As described above, the first section 202 is located completely at an exterior location of the container 12, while a second refrigerant system section 304 is located at least partially within the container 12.

The second section 304 is a pumped liquid-overfeed system. In other words, the second refrigerant (e.g., CO2) is pumped with a pump 350 from a low-pressure receiver 360 to one or more evaporators. In the illustrated embodiment, a first evaporator 361 and a second evaporator 362 are utilized, but it is to be appreciated that more or fewer evaporators may be employed in the loop. Each evaporator 361, 362 selectively receives the second refrigerant by regulation of the fluid via a respective valve 364, 366. The valves 364, 366 may be any type of flow regulating device, such as solenoid valves, as illustrated. The evaporators 361, 362 each partially evaporate the liquid state of the second refrigerant, resulting in a two-phase mixture.

The mixture is routed to the receiver 360 for mixture with a cooled liquid state of the second refrigerant. The cooled liquid state of the second refrigerant is cooled in heat exchanger 340 after interaction with the cooled first refrigerant therein. The receiver 360 is a low pressure receiver (i.e., relative to second refrigerant pressure) that maintains cooled liquid by pumping warm liquid out of the receiver 360 to the heat exchanger 340 with pump 380. A pressure signal 390 monitors the pressure of the receiver 360 to determine when pumping is appropriate for system requirements. For example, the cooling pump 350 is initiated when the pressure within the second receiver exceeds a predefined pressure, which is indicative of a threshold temperature of the second refrigerant stored within the receiver 360. The pump 350 distributes the cooled liquid to the evaporators, as described above. The pump 350 operates depending upon the demand of any of the evaporators.

The embodiments described herein ensure that the primary refrigerant system is kept outside of the compartment of the container 12, thereby eliminating any safety risk of leakage therein. Instead of a potentially more hazardous refrigerant being located within the container, a more desirable refrigerant (e.g., CO2) is utilized directly within the container 12. Separation of the primary refrigerant from the interior of the container 12 is therefore achieved. This minimizes the primary refrigerant charge and allows liquid CO2 to be distributed to the evaporators. In such embodiments, small line outer diameters on supply and return are achievable, with low pumping power. Additionally, no oil is required and a simple control scheme to each evaporator with solenoids or the like may be implemented. Only temperature sensors are required for each evaporator and a single sensor is required for the low pressure receiver. Overfed evaporators result in fully wet evaporation, providing the highest heat transfer coefficients.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., a processor, apparatus or system) to perform one or more methodological acts as described herein.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments have been described, it is to be understood that aspects of the disclosure may include only some of the described embodiments. Accordingly, the disclosure is not to be seen as limited by the foregoing description, but is only limited by the scope of the appended claims.

1. A transport refrigeration system comprising:
a container having an outer wall defining at least one compartment therein;
a first refrigerant system section disposed at an exterior location of the outer wall of the container, the first refrigerant system section having a first refrigerant routed therethrough for cooling of the first refrigerant;
a second refrigerant system section disposed at least partially within an interior location of the outer wall of the container, the second refrigerant system section having a second refrigerant that is different from the first refrigerant routed therethrough for cooling of the second refrigerant; and
a heat exchanger in fluid communication with the first refrigerant system section to receive the first refrigerant, the heat exchanger in fluid communication with the second refrigerant system section to receive the second refrigerant, the first refrigerant cooling the second refrigerant within the heat exchanger.

2. The transport refrigeration system of claim 1, wherein the second refrigerant is carbon dioxide.

3. The transport refrigeration system of claim 1, wherein the first refrigerant is one of HFC, HFO, and A2L.

4. The transport refrigeration system of claim 1, wherein the first refrigerant system section comprises a compressor, a condenser downstream of the compressor, and a first receiver, the heat exchanger in fluid communication with the receiver to selectively route the first refrigerant from the first receiver to the heat exchanger.

5. The transport refrigeration system of claim 1, wherein the second refrigerant system section comprises:
a second receiver in fluid communication with the heat exchanger to receive the second refrigerant in a saturated or subcooled liquid state from the heat exchanger; and
at least one evaporator downstream of the second receiver to receive the second refrigerant in a liquid state from the second receiver, the evaporator(s) for partial evaporation of the second refrigerant, a vapor portion of the second refrigerant utilized for cooling an interior of the compartment, a two-phase portion of the second refrigerant routed from the evaporator(s) to the heat exchanger.

6. The transport refrigeration system of claim 5, wherein the second refrigerant is pumped from the second receiver to at least one evaporator with a pump disposed between the second receiver and at least one evaporator, the flow to each evaporator regulated by a respective valve.

7. The transport refrigeration system of claim 6, wherein the valve(s) is a solenoid valve, the flow of the second refrigerant regulated based on demand for each of the at least one evaporator.

8. The transport refrigeration system of claim 1, wherein the container defines a plurality of compartments, each of the plurality of compartments allowing different controlled environmental conditions therein.

9. The transport refrigeration system of claim 1, wherein the second refrigerant system section comprises:
a second receiver in fluid communication with the heat exchanger to receive the second refrigerant in a cooled liquid state from the heat exchanger;
at least one evaporator downstream of the second receiver to receive the second refrigerant in a liquid state from the second receiver, the evaporator(s) for partial evaporation of the second refrigerant, a vapor portion of the second refrigerant utilized for cooling an interior of the compartment, a two-phase portion of the second refrigerant routed from the evaporator(s) back to the second receiver; and
a cooling pump for pumping the second refrigerant in a warmed liquid state from the second receiver to the heat exchanger for cooling therein.

10. The transport refrigeration system of claim 9, wherein the cooling pump is initiated when the pressure within the second receiver exceeds a predefined pressure.

11. The transport refrigeration system of claim 9, wherein the second refrigerant is pumped from the second receiver to the at least one evaporator with a pump disposed between the second receiver and the at least one evaporator, the flow to each evaporator regulated by a respective valve.

12. The transport refrigeration system of claim 11, wherein the valve(s) is a solenoid valve, the flow of the second refrigerant regulated based on demand for each of the at least one evaporator.

13. A method of regulating an environment of a transport container, the method comprising:
cooling a first refrigerant within a first refrigerant system section that is disposed at an exterior location of an outer wall of the transport container; and
cooling a second refrigerant within a second refrigerant system section that is at least partially disposed within an interior location of the outer wall of the transport container, the second refrigerant cooled by the first refrigerant in a heat exchanger, the first and second refrigerants different from each other.

14. The method of claim 13, wherein cooling the second refrigerant within the second refrigerant system section comprises:
routing the second refrigerant from the heat exchanger to a receiver for storage therein;
pumping the second refrigerant from the receiver to at least one evaporator for partial evaporation of the second refrigerant; and
routing the partially evaporated second refrigerant from the evaporator to the heat exchanger.

15. The method of claim 13, wherein cooling the second refrigerant within the second refrigerant system section comprises:
routing the second refrigerant from the heat exchanger to a receiver for storage therein;
pumping the second refrigerant from the receiver to at least one evaporator for partial evaporation of the second refrigerant;
routing the partially evaporated second refrigerant from the evaporator to the receiver;
monitoring a pressure within the receiver; and
pumping the second refrigerant from the receiver to the heat exchanger when the pressure within the receiver exceeds a predetermined pressure for cooling the second refrigerant.
